(19) United States
(12) Patent Application Publication
(10) Pub. No.: US 2025/0263592 A1
(43) Pub. Date: Aug. 21, 2025

(54) Thermally Conductive Silicone Adhesive Composition

(71) Applicant: Henkel AG & Co. KGaA, Duesseldorf (DE)

(72) Inventors: XingYu Zhu, Shanghai (CN); William JingJing Chang, Shanghai - WaiGaoQiao (CN); Dan Li, Shanghai (CN); Irene Yan Chen, Shanghai - WaiGaoQiao (CN); Jamey XiaoDan Chen, Shanghai (CN)

(21) Appl. No.: 19/194,873

(22) Filed: Apr. 30, 2025

Related U.S. Application Data
(63) Continuation of application No. PCT/CN2022/129257, filed on Nov. 2, 2022.

(51) Int. Cl. C09J 183/04; C08G 77/12; C08G 77/20; C08K 3/22; C08K 3/28; C09J 9/00; C09J 11/04; C09K 5/14

(52) U.S. Cl. CPC C09J 183/04; C08G 77/12; C08G 77/20; C09J 9/00; C09J 11/04; C09K 5/14; C08K 2003/2227; C08K 2003/282; C08K 2201/001; C08K 2201/005

(57) ABSTRACT

The present invention provides a thermally conductive silicone adhesive composition providing a combination of properties including good flowability and high thermal conductivity when cured, the composition comprising: (A) an alkenyl group-containing organopolysiloxane; (B) an organohydrogenpolysiloxane having an average of at least two hydrogen atoms directly bonded to a silicon atom in one molecule; (C) a thermally conductive filler; (D) a silane coupling agent; and (E) a catalyst; wherein the component (D) is present in an amount of less than 1% by weight based on the total weight of the composition.

### TECHNICAL FIELD

The present invention relates to a thermally conductive silicone adhesive composition, and particularly relates to a thermally conductive silicone adhesive composition exhibiting good flowability, as well as high thermal conductivity when cured, the preparation method and use thereof.

### BACKGROUND OF THE INVENTION

In recent years, along with size reduction and performance enhancement of electronic devices, there is an increasing demand for heat-dissipating compositions. Thermally conductive silicone adhesive compositions exhibiting good flowability and high thermal conductivity is widely used in electronic devices, especially the telecom and datacom devices, such as 5G station, or the like.

Such thermally conductive silicone adhesive compositions may be exemplified by the following: a thermally conductive silicone adhesive composition comprising an organopolysiloxane having vinyl groups, an organohydrogenpolysiloxane, a thermally conductive filler, an adhesion-imparting agent selected from epoxy silane or alkyl titanate, and a platinum-type catalyst. In order to improve thermal conductivity in a cured body obtained from such thermally conductive silicone adhesive compositions, the compositions must incorporate a large amount of thermally conductive fillers. However, an increase of the amount of such fillers impairs flowability of the composition causing nozzle blocking of conventional adhesive dispensers.

US 2020/0157350 A1 discloses thermally conductive polysiloxane composition comprising: (A) a thermally conductive filler; (B) a polyorganosiloxane resin having a curable functional group in the polysiloxane molecule, the polyorganosiloxane resin comprising at least one polysiloxane (bi) having one curable functional group in the molecule thereof; (C) a siloxane compound having an alkoxysilyl group and a linear siloxane structure; (D) a hydrogenpolyorganosiloxane; and (E) a platinum catalyst, wherein the content of the polysiloxane (b1) having one curable functional group in the molecule thereof in the polyorganosiloxane resin (B) is more than 80% by mass.

WO 2019/021825 A1 discloses a thermally conductive silicone gel composition comprising: (A) an alkenyl group-containing organopolysiloxane having a viscosity at 25° C. of 10 to 100,000 mPas in an amount of 100 parts by mass; (B) an organohydrogenpolysiloxane in an amount such that the silicon-bonded hydrogen atoms in component (B) are from 0.2 to 5 mol per mol of alkenyl groups in component (A); (C) a hydrosilylation reaction catalyst in a catalytic amount; (D) a thermally conductive filler in an amount from 1,200 to 7,500 parts by mass; (E) one or more silane coupling agents or hydrolyzed condensates thereof; and (F) an organopolysiloxane with specific structure; wherein the total amount of component (E) and component (F) is 0.1 to 5.0% by mass and the mass ratio of component (E) to component (F) is in a range from 5:95 to 95:5 when the total mass of component (D) in the composition is 100% by mass.

US20180134938 A1 discloses a thermally conductive composition good in thermal conductivity, low in viscosity and easy in application, including (A) a spherical thermally conductive filler and (B) an alkoxysilane compound or dimethylpolysiloxane, wherein the spherical thermally conductive filler of component (A) is a mixture formulated with specific ratios of fillers having different average particle sizes, the mixture being formulated with a spherical thermally conductive filler made of a nitride and having an average particle size of 50 μm or more in an amount of 30% by mass or more.

However, the thermal conductivity of the above disclosed compositions is no more than 10 W/(m·K), which cannot meet the increasing demand on heat-dissipating performance.

In view of the above, it is an object of the present invention to provide a thermally conductive silicone adhesive composition that has a favorable combination of properties including good flowability (more than 15 g/min at 25° C.) and high thermal conductivity when cured (more than 10 W/(m·K)).

### SUMMARY OF THE INVENTION

Disclosed herein is a thermally conductive silicone adhesive composition comprising:
(A) an alkenyl group-containing organopolysiloxane;
(B) an organohydrogenpolysiloxane having an average of at least two hydrogen atoms directly bonded to a silicon atom in one molecule;
(C) a thermally conductive filler;
(D) a silane coupling agent; and
(E) a catalyst;
wherein the component (D) is selected from the general formulae (i) to (iii) shown below and mixture thereof:

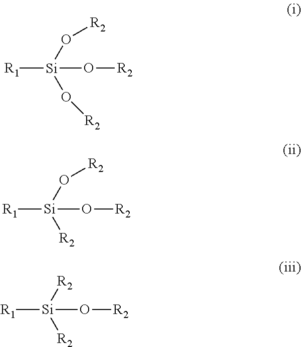

in which in each formula, R₁ independently represents a hydrogen or vinyl group, and R₂ independently represents an alkyl group having 1 to 4 carbon atoms; and the component (D) is present in an amount of less than 1% by weight based on the total weight of the composition.

Also disclosed herein is the method for preparing a thermally conductive silicone adhesive composition according to the present invention.

Also disclosed herein is the cured product of the thermally conductive silicone adhesive composition according to the present invention.

Also disclosed herein is the use of the thermally conductive silicone adhesive composition and the cured product of the thermally conductive silicone adhesive composition according to the present invention in manufacturing electronic devices.

Other features and aspects of the subject matter are set forth in greater detail below.

### DETAILED DESCRIPTION OF THE INVENTION

It is to be understood by one of ordinary skill in the art that the present invention is a description of exemplary embodiments only and is not intended as limiting the broader aspects of the present invention. Each aspect so described may be combined with any other aspect or aspects unless clearly indicated to the contrary. In particular, any feature indicated as being preferred or advantageous may be combined with any other feature or features indicated as being preferred or advantageous.

Unless specified otherwise, in the context of the present invention, the terms used are to be construed in accordance with the following definitions.

Unless specified otherwise, as used herein, the terms “a”, “an” and “the” include both singular and plural referents.

The terms “comprising” and “comprises” as used herein are synonymous with “including”, “includes” or “containing”, “contains”, and are inclusive or open-ended and do not exclude additional, non-recited members, elements or process steps.

The term “room temperature” as used herein refers to a temperature of about 20° C. to about 25° C., preferably about 25° C.

The molecular weights refer to weight average molecular weights (Mw), unless otherwise stipulated.

All molecular weight data refer to values obtained by gel permeation chromatography (GPC), unless otherwise stipulated, e.g. according to DIN 55672.

Unless specified otherwise, the recitation of numerical end points includes all numbers and fractions subsumed within the respective ranges, as well as the recited end points.

All references cited in the present specification are hereby incorporated by reference in their entirety.

Unless otherwise defined, all terms used in the present invention, including technical and scientific terms, have the meaning as commonly understood by one of the ordinary skilled in the art to which this invention belongs.

In one aspect, the present disclosure is generally directed to thermally conductive silicone adhesive composition comprising:
(A) an alkenyl group-containing organopolysiloxane;
(B) an organohydrogenpolysiloxane having an average of at least two hydrogen atoms directly bonded to a silicon atom in one molecule;
(C) a thermally conductive filler;
(D) a silane coupling agent; and
(E) a catalyst;
wherein the component (D) is selected from the general formulae (i) to (iii) shown below and mixture thereof:

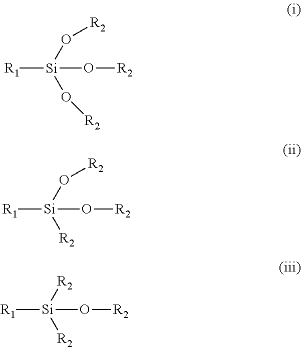

in which in each formula, R₁ independently represents a hydrogen or vinyl group, and R₂ independently represents an alkyl group having 1 to 4 carbon atoms; and the component (D) is present in an amount of less than 1% by weight based on the total weight of the composition.

### (A) Alkenyl Group-Containing Organopolysiloxane

According to the present invention, the thermally conductive silicone adhesive composition comprises (A) an alkenyl group-containing organopolysiloxane.

As used herein, “alkenyl” refers to a radical of a straight-chain or branched hydrocarbon group having from 2 to 40 carbon atoms and one or more carbon-carbon double bonds (e.g., 1, 2, 3, or 4 double bonds) (“C₂₋₄₀ alkenyl”). In some embodiments, an alkenyl group has 2 to 30 carbon atoms (“C₂₋₃₀ alkenyl”). In some embodiments, an alkenyl group has 2 to 20 carbon atoms (“C₂₋₂₀ alkenyl”). In some embodiments, an alkenyl group has 2 to 10 carbon atoms (“C₂₋₁₀ alkenyl”). In some embodiments, an alkenyl group has 2 to 9 carbon atoms (“C₂₋₉ alkenyl”). In some embodiments, an alkenyl group has 2 to 8 carbon atoms (“C₂₋₈ alkenyl”). In some embodiments, an alkenyl group has 2 to 7 carbon atoms (“C₂₋₇ alkenyl”). In some embodiments, an alkenyl group has 2 to 6 carbon atoms (“C₂₋₆ alkenyl”). In some embodiments, an alkenyl group has 2 to 5 carbon atoms (“C₂₋₅ alkenyl”). In some embodiments, an alkenyl group has 2 to 4 carbon atoms (“C₂₋₄ alkenyl”). In some embodiments, an alkenyl group has 2 to 3 carbon atoms (“C₂₋₃ alkenyl”). In some embodiments, an alkenyl group has 2 carbon atoms (“C₂ alkenyl”). The one or more carbon-carbon double bonds can be internal (such as in 2-butenyl) or terminal (such as in 1-butenyl). Examples of C₂₋₄ alkenyl groups include ethenyl (C₂), 1-propenyl (C₃), 2-propenyl (C₃), 1-butenyl (C₄), 2-butenyl (C₄), butadienyl (C₄), and the like. Examples of C₂₋₆ alkenyl groups include the aforementioned C₂₋₄ alkenyl groups as well as pentenyl (C₅), pentadienyl (C₅), hexenyl (C₆), and the like. Additional examples of alkenyl include heptenyl (C₇), octenyl (Cs), octatrienyl (C₈), and the like. Unless otherwise specified, each instance of an alkenyl group is independently unsubstituted (an “unsubstituted alkenyl”) or substituted (a “substituted alkenyl”) with one or more substituents. In certain embodiments, the alkenyl group is an unsubstituted C₂₋₃₀ alkenyl. In certain embodiments, the alkenyl group is a substituted C₂₋₃₀ alkenyl.

In some embodiments, the quantity of alkenyl groups is within a range from 0.01 to 10 wt. %, and preferably from 0.1 to 5 wt. % based on the total weight of the organopolysiloxane. Furthermore, these alkenyl groups may be bonded to silicon atoms at the terminals of the molecular chain, to non-terminal silicon atoms within the molecular chain, or to both these types of silicon atoms, although from the viewpoints of ensuring a good curing rate for the composition and producing favorable physical properties for the cured product, the organopolysiloxane should comprise at least alkenyl groups bonded to a molecular chain terminal silicon atom, and preferably to the silicon atoms at both terminals of the molecular chain.

In some embodiments, the viscosity at 25° C. of the component (A) is within a range from 10 to 1000 mPa·s, and preferably from 10 to 500 mPa·s. If the viscosity at 25° C. is within the range defined above, then the physical characteristics of the cured silicone adhesive can be improved. The viscosity herein was measured with TA Rheometer parallel plate using spindle 25 mm under 60 rpm, 25° C.

There are no particular restrictions on the molecular structure of the component (A), including but not limited to straight chain structures, cyclic structures, branched chain structures, partially branched straight chain structures and three-dimensional network structures, although an essentially straight chain diorganopolysiloxane in which the principal chain is formed from repeating diorganosiloxane units, and both terminals of the molecular chain are blocked with triorganosiloxy groups, is preferred. Furthermore, the component (A) may be a single polymer with this type of molecular structure, a copolymer with this type of molecular structure, or a mixture of different polymers with this type of molecular structure.

Specific examples of the component (A) include the compounds represented by the general formulae (iv) to (viii) shown as below.

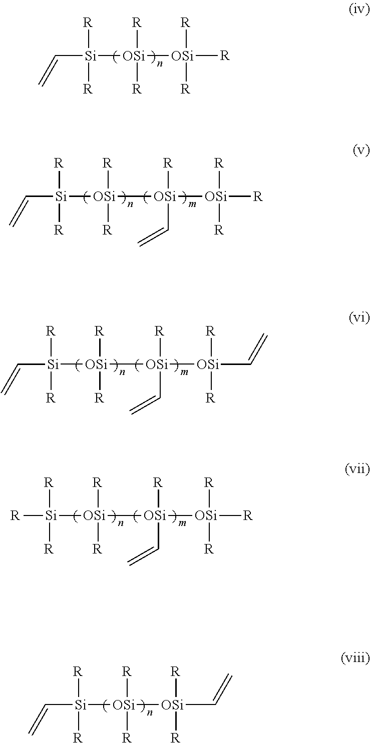

In the formulae (iv) to (viii) above, R each independently represents a substituted or unsubstituted monovalent hydrocarbon group bonded to a silicon atom, but excluding alkenyl groups, as described above, and is preferably a methyl group or a phenyl group. In the formulae (iv) to (viii), n is an integer of from 0 to 5000, m is an integer of from 5 to 5000, and the sum of n and m ranges from 5 to 10000. In some embodiments, n ranges from as little as 0, 10, 50, 100, 200, 500, as great as 1000, 2000, 5000, or within any range defined between any two of the foregoing values; and m ranges from 5, 10, 50, 200, or as great as 500, 1000, 2000, 5000, or within any range defined between any two of the foregoing values. In addition, the sum of n and m ranges from as little as 5, 10, 30, 50, 100, 200, 500, or great as 1000, 2000, 5000, 10000, or within any range defined between any two of the foregoing values, such as between 10 and 10000, and between 1000 and 5000.

In some embodiments, the unsubstituted or substituted monovalent hydrocarbon group R in the formulae (iv) to (viii) above is each independently selected from straight-chain alkyl groups, preferably selected from methyl group, ethyl group, n-propyl group, n-butyl group, n-pentyl group, n-hexyl group, n-heptyl group, n-octyl group, n-nonyl group, n-decyl group, n-undecyl group, n-dodecyl group, n-tridecyl group, n-tetradecyl group, n-pentadecyl group, n-hexadecyl group, n-heptadecyl group, n-octadecyl group, n-nonadecyl group, and n-eicosyl group; branched-chain alkyl groups, preferably selected from isopropyl group, t-butyl group, isobutyl group, 2-methylundecyl group, and 1-hexylheptyl group; cyclic alkyl groups, preferably selected from a cyclopentyl group, cyclohexyl group, and cyclododecyl group; aryl groups, preferably selected from a phenyl group, tolyl group, and xylyl group; aralkyl groups, preferably selected from a benzyl group, phenethyl group, and 2-(2,4,6-trimethylphenyl) propyl group; and halogenated alkyl groups, preferably selected from 3,3,3-trifluoropropyl group and 3-chloropropyl group; preferably selected from straight-chain alkyl groups and aryl groups; and more preferably selected from methyl group, ethyl group and phenyl groups.

In one preferred embodiment, component (A) is selected from vinyl terminated polydimethylsiloxane, vinyl terminated diphenylsiloxane-dimethylsiloxane copolymer, vinyl terminated polyphenylsiloxane, vinylbenzyl terminated vinylphenylsiloxane-phenylmethylsiloxane copolymer, vinyl terminated trifluoropropylmethylsiloxane-dimethylsiloxane copolymer, vinyl terminated diethylsiloxane-dimethylsiloxane copolymer, vinylmethylsiloxane-dimethylsiloxane copolymer, trimethylsilanyl terminated vinylmethylsiloxane-dimethylsiloxane copolymer, silanol terminated vinylmethylsiloxane-dimethylsiloxane copolymer, vinylmethylsiloxane homopolymer, vinylmethylsiloxane copolymer, vinyl terminated poly (methyl siloxane) copolymer, vinyl terminated poly (methyl siloxane) copolymer, vinyl terminated poly (methyl siloxane) copolymer, poly (vinyl terminated poly (methyl siloxane) copolymer, poly (vinyl terminated poly (vinyl siloxane) and poly (vinyl siloxane) copolymer, monovinyl-terminated polydimethylsiloxane, vinylmethylsiloxane terpolymers, vinylmethoxysilane homopolymers, or combinations thereof.

There are no particular restrictions on the molecular weight of component (A), and preferably in the range of from 3000 to 20,000 g/mol.

The component (A) may be used either alone, or in combinations of two or more different compounds.

Such alkenyl group-containing organopolysiloxane used as component (A) can be produced using conventionally known methods. In a typical production method, the alkenyl group-containing organopolysiloxane is produced by conducting an equilibration reaction of an organocyclooligosiloxane and a hexaorganodisiloxane in the presence of either an alkali or acid catalyst.

Examples of commercially available products of the component (A) include vinyl terminated polydimethylsiloxane from Vi 393, Vi70E and Vi100E manufactured by Zhejiang Runhe Chemical New Material Co., Ltd.

According to the present invention, the component (A) is present in an amount of from 0.01% to 5%, preferably 0.05% to 4% by weight, based on the total weight of the composition.

### (B) Organohydrogenpolysiloxane

According to the present invention, the thermally conductive silicone adhesive composition also comprises (B) an organohydrogenpolysiloxane having an average of at least two hydrogen atoms directly bonded to a silicon atom in one molecule, which works as a crosslinking agent to the component (A) to form silicone polymer matrix.

In one embodiment, the organohydrogenpolysiloxane has two or more —Si—H groups in one molecule. The —Si—H groups in the component (B) and alkenyl groups in the component (A) are added by a hydrosilylation reaction promoted by (E) catalyst described below to generate a three-dimensional network structure having a crosslinked structure.

The component (B) may have an average of at least two, and preferably three or more —Si—H groups per molecule, and these —Si—H groups may be positioned at the terminals of the molecular chain, at non-terminal positions, or at both these positions.

In one embodiment, the organohydrogenpolysiloxane is linear or branched, and in preferred embodiments, the organohydrogenpolysiloxane can be represented by the general formula (ix):

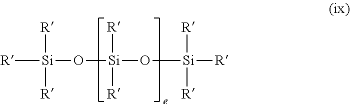

In the above formula (ix), R′ each independently represents a hydrogen atom or an unsubstituted or substituted monovalent hydrocarbon group excluding aliphatic unsaturated bonds and at least two R′ groups are hydrogen atoms. Index e represents an integer of 1 or more.

Suitable examples of the unsubstituted or substituted monovalent hydrocarbon group in the general formula (ix) is each independently selected from straight-chain alkyl groups, preferably selected from methyl group, ethyl group, n-propyl group, n-butyl group, n-pentyl group, n-hexyl group, n-heptyl group, n-octyl group, n-nonyl group, n-decyl group, n-undecyl group, n-dodecyl group, n-tridecyl group, n-tetradecyl group, n-pentadecyl group, n-hexadecyl group, n-heptadecyl group, n-octadecyl group, n-nonadecyl group, and n-eicosyl group; branched-chain alkyl groups, preferably selected from isopropyl group, t-butyl group, isobutyl group, 2-methylundecyl group, and 1-hexylheptyl group; cyclic alkyl groups, preferably selected from a cyclopentyl group, cyclohexyl group, and cyclododecyl group; aryl groups, preferably selected from a phenyl group, tolyl group, and xylyl group; aralkyl groups, preferably selected from a benzyl group, phenethyl group, and 2-(2,4,6-trimethylphenyl) propyl group; and halogenated alkyl groups, preferably selected from 3,3,3-trifluoropropyl group and 3-chloropropyl group; preferably selected from straight-chain alkyl groups and aryl groups; and more preferably selected from methyl group, ethyl group and phenyl groups.

The functionality content of —Si—H groups in the component (B) is preferably in the range of from 0.1 to 10.0 mmol/g, more preferably from 0.1 to 5.0 mmol/g.

In preferred embodiments, the number of moles of the —Si—H groups contained in the component (B) is preferable in an amount that 0.1 to 5.0 times the number of moles of the alkenyl groups derived from the component (A).

Specific examples of component (B) include but not limited to 1,1,3,3-tetramethyldisiloxane, dimethylhydrosiloxane, methylhydrogencyclopolysiloxane, cyclic copolymers of methylhydrogensiloxane and dimethylsiloxane, methylhydrogenpolysiloxane with both terminals blocked with trimethylsiloxy groups, copolymers of dimethylsiloxane and methylhydrogensiloxane with both terminals blocked with trimethylsiloxy groups, dimethylpolysiloxane with both terminals blocked with dimethylhydrogensiloxy groups, copolymers of dimethylsiloxane and methylhydrogensiloxane with both terminals blocked with dimethylhydrogensiloxy groups, copolymers of methylhydrogensiloxane and diphenylsiloxane with both terminals blocked with trimethylsiloxy groups, copolymers of methylhydrogensiloxane, diphenylsiloxane and dimethylsiloxane with both terminals blocked with trimethylsiloxy groups, copolymers of methylhydrogensiloxane, dimethylsiloxane and diphenylsiloxane with both terminals blocked with dimethylhydrogensiloxy groups.

The component (B) can be produced using conventionally known methods. In a typical production method, octamethylcyclotetrasiloxane and/or tetramethylcyclodisiloxane, and a compound to from the terminal groups such as hexamethyldisiloxane or a compound incorporating a 1,1′-dihydro-2,2′,3,3′-tetramethyldisiloxane unit are subjected to equilibration in the presence of a catalyst such as sulfuric acid, trifluoromethanesulfonic acid or methanesulfonic acid, at a temperature of −10° C. to 40° C. Commercial products can be available as well. Examples of commercially available products of the component (B) include dimethylhydrosiloxane from RH-H86 and H3, hydrogen terminated polydimethylsiloxane from DH04, and polydimethylmethylhydrosiloxane from H57, all manufactured by Zhejiang Runhe Chemical New Material Co., Ltd.

According to the present invention, the component (B) is present in an amount of from 0.01% to 5%, preferably 0.05% to 3% by weight, based on the total weight of the composition.

### (C) Thermally Conductive Filler

According to the present invention, the thermally conductive silicone adhesive composition comprises (C) a thermally conductive filler.

In some embodiments, the component (C) can be selected from alumina particles, aluminum nitride particles, fumed silica particles, precipitated silica particles, fumed titanium oxide particles and combinations thereof, preferably alumina particles, aluminum nitride particles and combinations thereof.

In some embodiment, the component (C) has a D₅₀ particle size of no more than 200 μm, preferably no more than 100 μm.

Herein, the “D₅₀ particle size” represents a median diameter in a volume-basis particle size distribution curve obtained by measurement with a laser diffraction particle size analyzer.

In preferred embodiments, the component (C) comprises at least one alumina particles having a D₅₀ particle size of 0.01 μm to 2 μm, preferably from 0.1 μm to 1 μm and at least one aluminum nitride particles having a D₅₀ particle size of 1 μm to 200 μm, preferably from 1 μm to 100 μm.

In preferred embodiments, the component (C) comprises at least one alumina particles having a D₅₀ particle size of 0.01 μm to 2 μm, preferably from 0.1 μm to 1 μm, at least one aluminum nitride particles having a D₅₀ particle size of 50 μm to 100 μm, preferably from 70 μm to 100 μm, and at least one aluminum nitride particles having a D₅₀ particle size of 1 μm to 50 μm, preferably from 1 μm to 30 μm.

The shape of the component (C) used in the present invention is not particularly limited. They may have spherical, rod-like, needle-like, disc-like, or amorphous shape, preferably spherical shape. In this description, the term “spherical” refers to a shape in which the entire surface is formed from a convex smooth surface.

The component (C) can be surface treated or non-surface treated. It is preferably to use surface-treated particles as component (C) in the present invention to increase the compatibility with component (C) in silicone polymer matrix. The particle can be surface treated with a surface treating agent such as a silane compound, an organotitanium compound, an organoaluminum compound or a phosphate compound, and preferably with the silane compound.

In preferred embodiments, the amount of the surface treating agent adhered to the thermal particles is, with respect to the weight of thermal particles, for example, from 0.01% to 2% by weight, preferably from 0.02% to 1.5% by weight, more preferably from no less than 0.03% to 1% by weight. If the content of surface treating agent is within the range defined above, the thermal particles will have improved compatibility with other thermal particles.

The silane compound to be used for the surface treatment is not especially limited, and examples thereof include alkoxysilanes and chlorosilanes; and the alkoxysilanes are preferable. When the thermal particles surface-treated with the silane compound, it is easy to conform to the silicone polymer matrix, making it easy for the amount of the thermal particles blended in the thermally conductive composition to be increased.

Examples of the alkoxysilanes include alkoxysilanes having a reactive group and alkoxysilanes having no reactive group. The reactive group of the alkoxysilanes having a reactive group is selected, for example, from an epoxy group, a (meth) acryloyl group, an amino group, a vinyl group, a ureido group, a mercapto group and an isocyanate group.

Examples of alkoxysilanes having an epoxy group include 2-(3,4-epoxycyclohexyl)ethyltrimethoxysilane, 3-glycidoxypropyltrimethoxysilane, 3-glycidoxypropylmethyldiethoxysilane and 3-glycidoxypropyltriethoxysilane. Examples of alkoxysilanes having a (meth)acryloyl group include 3-(meth)acryloxypropylmethyldimethoxysilane, 3-(meth)acryloxypropyltrimethoxysilane, 3-(meth)acryloxypropylmethyldiethoxysilane and 3-(meth)acryloxypropyltriethoxysilane. Examples of silane compounds having an amino group include alkoxysilanes such as N-(2-aminoethyl)-3-aminopropylmethyldimethoxysilane, N-(2-aminoethyl)-3-aminopropyltrimethoxysilane, N-(2-aminoethyl)-3-aminopropyltriethoxysilane, 3-aminopropyltrimethoxysilane, 3-aminopropyltriethoxysilane and N-phenyl-3-aminopropyltrimethoxysilane. Examples of silane compounds having a vinyl group include vinyltrimethoxysilane and vinyltriethoxysilane. Examples of alkoxysilanes having a mercapto group include 3-mercaptopropyltrimethoxysilane and 3-mercaptopropylmethyldimethoxysilane. Examples of alkoxysilanes having a ureido group include 3-ureidopropyltrimethoxysilane. Examples of alkoxysilanes having an isocyanate group include 3-isocyanatopropyltriethoxysilane. Further, Examples of the alkoxysilanes having no reactive group include trialkoxysilanes such as aryltrialkoxysilanes, alkyltrialkoxysilanes, and dialkoxysilanes such s dialkyldialkoxysilanes and diaryldialkoxysilanes, and among these, trialkoxysilanes such as alkyltrialkoxysilanes are preferable. Examples of the alkyltrialkoxysilanes include alkyltrialkoxysilanes in which the number of carbon atoms of the alkyl group is about 1 to 10, such as methyltrimethoxysilane, methyltriethoxysilane, n-proyltrimethoxysilane, n-propyltriethoxysilane, n-hexyltrimethoxysilane, n-hexyltriethoxysilane, n-octyltriethoxysilane and n-decyltrimethoxysilane. Further, Examples of the aryltrimethoxysilanes include aryltrimethoxysilanes in which the number of carbon atoms of the aryl group is about 6 to 10, such as phenyltrimethoxysilane, benzyltrimethoxy silane and tolyltrimethoxysilane. Further, Examples of the dialkoxysilanes include dimethyldimethoxysilane and dimethyldiethoxysilane. As a preferable aspect of the silane compounds, there is used a polymeric silane compound being a reaction product of an alkoxysilane having a reactive group with a polyorganosiloxane having a functional group reactive with the reactive group.

The suitable polymeric silane compound can be obtained, for example, by mixing the alkoxysilane having a reactive group with the polyorganosiloxane and allowing these to react under heating in the presence of a catalyst such as a platinum-based catalyst, a palladium-based catalyst or a rhodium-based catalyst. As the alkoxysilane having a reactive group, the ones listed in the above can be used, but among the above, it is preferable to use trialkoxysilanes. As the alkoxysilane having a reactive group, silane compounds having a (meth)acryloyl group or a vinyl group are preferable, and trialkoxysilanes having a (meth)acryloyl group are more preferable. When a silane compound having a (meth)acryloyl group or a vinyl group is used, since the silane compound easily reacts with an organopolysiloxane having hydrosilyl groups (—SiH) described later, a polymeric silane compound can be obtained by a simple method. The polyorganosiloxane having a functional group to be used for the polymeric silane compound may have one functional group or may have two or more functional groups. In the case of having two or more functional groups, two or more molecules of the alkoxysilane having a reactive group may be bonded to one molecule of the polyorganosiloxane. The polyorganosiloxane having a functional group is preferably an organopolysiloxane having hydrosilyl groups (—SiH). Examples of the organopolysiloxane having hydrosilyl groups (—SiH) include methylhydrosiloxane-dimethylsiloxane copolymers and methylhydrosiloxane-phenylmethylsiloxane copolymers. These may contain hydrosilyl groups on the terminals, or may not. The weight-average molecular weight of the polyorganosiloxane having a functional group is preferably 800 to 5000 and more preferably 1500 to 4000. Here, the weight-average molecular weight is a value in terms of polystyrene measured by GPC.

A method of the surface treatment using the silane compound is not especially limited, and may be a well-known method; and there can be used, for example, a wet treatment method, a dry treatment method or a pretreatment method. In the present invention, among these, the wet treatment method is preferable. In the wet treatment method, the surface treatment can be made, for example, by adding the thermal particles in a solution in which the silane compound is dispersed or dissolved, mixing the mixture, and thereafter heat-treating the mixture to bond or adhere the silane compound to the surface of the thermal particles. The dry treatment method is a method of the surface treatment using no solution, and specifically, is a method in which the thermal particles are mixed with the silane compound and stirred by a mixer or the like, and thereafter heat-treated to bond or adhere the silane compound to the surface of the thermal particles.

Suitable commercially available examples of the component (C) include alumina particles from AN5, AN20 and AN30 manufactured by Suzhou Ginet New Material Technology Co., Ltd, AA04 manufactured by Sumitomo Chemical, NSM-1 and BAK-2 manufactured by Bestry Performance Materials Co., Ltd., DAM-03 manufactured by Denka Corporation; aluminum nitride particles from AN80, AND-A-01 manufactured by Suzhou Ginet New Material Technology Co., Ltd.

In particular preferred embodiments, the component (C) is present in an amount of from 0.01% to 99%, preferably from 50% to 99% by weight, based on the total weight of composition.

### (D) Silane Coupling Agent

According to the present invention, the thermally conductive silicone adhesive composition comprises (D) a silane coupling agent selected from the general formulae (i) to (iii) shown below and mixture thereof:

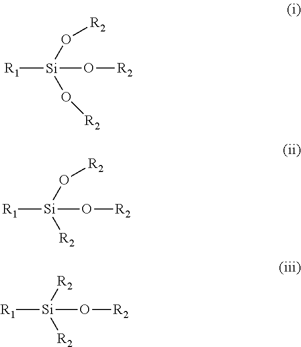

wherein in each formula, R₁ independently represents a hydrogen or vinyl group, and R₂ independently represents an alkyl group having 1 to 4 carbon atoms; and the component (D) is present in an amount of less than 1% by weight based on the total weight of the composition.

Suitable silane coupling agent, which can be used in the present invention, includes, but not limited to, trimethoxysilane, dimethoxy(methyl) silane, dimethoxy (ethyl) silane, dimethoxy (propyl) silane, dimethoxy (butyl) silane, vinyltrimethoxysilane, vinyltriethoxysilane, vinyldimethoxy(methyl) silane and the like.

Examples of commercially available examples of silane coupling agent include D2100, T1035 from TCI, Silquest A 2171, Silquest A 171 from Momentive.

In one embodiment, the component (D) is present in an amount of from 0.01% to less than 1% by weight, preferably from 0.05% to less than 1% by weight, and more preferably from 0.05% to less than 0.5% by weight based on the total weight of composition. If the quantity falls within this range, then thermal conductivity of the cured product derived from the present composition can be improved.

### (E) Catalyst

According to the present invention, the thermally conductive silicone adhesive composition comprises (E) a catalyst for accelerating the process of curing.

The component (E) is a catalyst for promoting an addition reaction of an alkenyl group derived from the component (A), and a —Si—H group derived from the component (B), and a catalyst well-known as a catalyst used in a hydrosilylation reaction may be used.

Specific examples thereof include platinum group metal simple substance such as platinum (including platinum black), rhodium, and palladium; platinum chloride, chloroplatinic acid and chloroplatinate such as H₂PtCl₄·nH₂O, H₂PtCl₆·nH₂O, NaHPtCl₆·nH₂O, KaHPtCl₆·nH₂O, Na₂PtCl₆·H₂O, K₂PtCl₄·nH₂O, PtCl₄·nH₂O, PtCl₂, and Na₂HPtCl₄·nH₂O (here, in the formula, n is an integer of 0 to 6, preferably alcohol-modified chloroplatinic acid); complexes of chloroplatinic acid and olefin; ones obtained by supporting a platinum group metal such as platinum black and palladium on a support such as alumina, silica or carbon; a rhodium-olefin complex, chlorotris (triphenylphosphine) rhodium (Wilkinson catalyst); and, complexes of platinum chloride, chloroplatinic acid or chloroplatinate and a vinyl group-containing siloxane, in particular, a vinyl group-containing cyclic siloxane may be used.

Suitable commercially available examples of catalysts include CATALYST 512 from Evonik and CAT-50 available from Avantor.

According to the present invention, the component (E) is present in an amount of from 0.001% to 0.1% by weight, preferably from 0.001% to 0.05% by weight, based on the total weight of the composition.

### (F) Additive

In some embodiments, the thermally conductive silicone adhesive composition may further optionally comprise additive selected from inhibitors, pigments, dyes, fluorescent dyes, heat resistant additives, flame retardants, plasticizers, adhesion-imparting agents and combinations thereof, provided that the inclusion of these additives does not impair the object of the present invention.

Suitable examples of inhibitor used in the present invention, including but not limited to an acetylene-based compound such as 2-methyl-3-butyn-2-ol, 2-phenyl-3-butyn-2-ol, or 1-ethynyl-1-cyclohexanol; a hydrazine-based compound; a phosphine-based compound; or a mercaptan-based compound, in order to regulate the curing rate of the composition, thereby enabling an improvement in the flowability and workability properties.

Suitable commercially available examples of the inhibitor include Inhibitor MVC from Evonik and 3,5-dimethyl-1-hexyn-3-ol from Sigma-Aldrich Company.

Suitable commercially available examples of the pigment include red pigment manufactured by Lanxess.

In those cases where the composition of the present invention comprises additive, there are no particular restrictions on the quantity of the additive, although a quantity within a range from 0.0001 to 1.0% by weight, based on the total weight of the composition is preferred.

In particular preferred embodiments, the thermally conductive silicone adhesive composition, based on the total weight of the composition, comprises:
(A) from 0.01% to 5%, preferably 0.05% to 4% by weight of an alkenyl group-containing organopolysiloxane;
(B) from 0.01% to 5%, preferably 0.05% to 3% by weight of an organohydrogenpolysiloxane having an average of at least two hydrogen atoms directly bonded to silicon atom in one molecule,
(C) from 0.01% to 99% by weight, more preferably from 50% to 99% by weight of a thermally conductive filler,
(D) from 0.01% to less than 1% by weight, preferably from 0.05% to less than 1% by weight, and more preferably from 0.05% to less than 0.5% by weight of a silane coupling agent,
(E) from 0.001% to 0.1% by weight, preferably from 0.001% to 0.05% by weight of a catalyst, and
(F) from 0 to 1.0% by weight of an additive;
wherein the component (D) is selected from the general formulae (i) to (iii) shown below and mixture thereof:

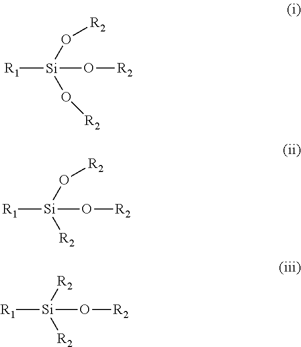

in which in each formula, R₁ independently represents a hydrogen or vinyl group, and R₂ independently represents an alkyl group having 1 to 4 carbon atoms.

A further aspect of the present invention relates to a method for preparing a thermally conductive silicone adhesive composition by mixing the said components simultaneously at room temperature for such as at least one hour, preferably at least two hours.

The thermally conductive silicone adhesive composition of the present invention has a good flowability when cured with the thermally conductive filler loading of more than 80%, for example, having a flow rate more than 15 g/min, preferably more than 18 g/min, defined as the adhesive composition weight dispensed under a pressure of 90 psi per minute using dispenser machine Nordson Ultimus™-I equipped with a 30 cc plastic tube having a nozzle in a diameter of 2.54+5% mm. Such flow rate, especially more than 15 g/min ensures that the nozzle of conventional adhesive dispensers will not be blocked by the adhesive composition after mixing.

In preferred embodiments, the thermally conductive silicone adhesive composition can cure at room temperature for no more than 7 days. Curing can be accelerated by applying heat, for example, by heating from 60 to 200° C. for from 30 minutes to 2 hours.

In the present invention, the thermally conductive silicone adhesive composition can be applied to the desired substrate by any convenient technique. It can be applied cold or be applied warm if desired. It can be applied by extruding or pasting it onto the substrate or other mechanical application methods such as a caulking gun. Generally, the thermally conductive silicone adhesive composition of the present invention is applied to one surface of a pair of substrates, and then the substrates are contacted each other to be bonded together. After application, the thermally conductive silicone adhesive composition of the present invention cures at room temperature, optionally followed by curing at elevated temperature.

In another aspect of the present invention, provided is an article comprising a first substrate, a cured adhesive, and a second substrate bonded to the first substrate through the cured adhesive comprising a cured product derived from the curable adhesive composition according to any one of the preceding claims.

The first substrate and/or second substrate can be of a single material and a single layer or can include multiple layers of the same or different material. The layers can be continuous or discontinuous.

The substrates of the article described herein can have a variety of properties including rigidity (e.g., rigid substrates (i.e., the substrate cannot be bent by an individual using two hands or will break if an attempt is made to bend the substrate with two hands), flexibility (e.g., flexible substrates (i.e., the substrate can be bent using no greater than the force of two hands), porosity, conductivity, lack of conductivity, and combinations thereof.

The substrates of the article can be in a variety of forms including, e.g., fibers, threads, yarns, wovens, nonwovens, films (e.g., polymer film, metallized polymer film, continuous films, discontinuous films, and combinations thereof), foils (e.g., metal foil), sheets (e.g., metal sheet, polymer sheet, continuous sheets, discontinuous sheets, and combinations thereof), and combinations thereof.

Useful substrate material used in the present invention include, e.g., polymer (e.g., polycarbonate, ABS resin (acrylonitrile-Butadiene-Styrene resin), liquid crystal polymer, polyolefin (e.g., polypropylene, polyethylene, low density polyethylene, linear low density polyethylene, high density polyethylene, polypropylene, and oriented polypropylene, copolymers of polyolefins and other comonomers), polyether terephthalate, ethylene-vinyl acetate, ethylene-methacrylic acid ionomers, ethylene-vinyl-alcohols, polyesters, e.g. polyethylene terephthalate, polycarbonates, polyamides, e.g. Nylon-6 and Nylon-6,6, polyvinyl chloride, polyvinylidene chloride, cellulosics, polystyrene, and epoxy), polymer composites (e.g., composites of a polymer and metal, cellulose, glass, polymer, and combinations thereof), metal (aluminum, copper, zinc, lead, gold, silver, platinum, and magnesium, and metal alloys such as steel (e.g., stainless steel), tin, brass, and magnesium and aluminum alloys), carbon-fiber composite, other fiber-based composite, graphene, fillers, glass (e.g., alkali-aluminosilicate toughened glass and borosilicate glass), quartz, boron nitride, gallium nitride, sapphire, silicon, carbide, ceramic, and combinations thereof, preferably liquid crystal polymer, glass and combinations thereof.

The cured product of the thermally conductive silicone adhesive composition of the present invention has a thermal conductivity of more than 10 W/(m·K), preferably more than 11 W/(m·K) measured according to ASTM-D5470.

A further aspect in connection with the present invention relates to the use of the thermally conductive silicone adhesive composition and the cured product of the thermally conductive silicone adhesive composition according to the present invention in manufacturing electronic devices, especially telecom and datacom devices, such as 5G station, or the like.

Exemplary electronic devices encompass computers and computer equipment, such as telecom and datacom devices, such as 5G station, or the like; printers, fax machines, scanners, keyboards and the like; medical sensors; automotive sensors and the like; wearable electronic devices (e.g., wrist watches and eyeglasses) and their integrated circuit elements, handheld electronic devices (e.g., phones (e.g., cellular telephones and cellular smartphones) and their integrated circuit elements, cameras, tablets, electronic readers, monitors (e.g., monitors used in hospitals, and by healthcare workers, athletes and individuals), watches, calculators, mice, touch pads, and joy sticks), computers (e.g., desk top and lap top computers) and their integrated circuit elements, computer monitors, televisions, media players, household appliances (e.g., refrigerators, washing machines, dryers, ovens, and microwaves), light bulbs (e.g., incandescent, light emitting diode, and fluorescent), and articles that include a visible transparent or transparent component, glass housing structures, protective transparent coverings for a display or other optical component.

Preferred in accordance with the invention is the use of the embodiments identified earlier on above as being preferred or more preferred, for the thermally conductive silicone adhesive composition of the present invention, where preferably two or more of the aspects or corresponding features described for the thermally conductive silicone adhesive composition are combined with one another.

### EXAMPLES

The following examples are intended to assist one skilled in the art to better understand and practice the present invention. The scope of the invention is not limited by the examples but is defined in the appended claims. All parts and percentages are based on weight unless otherwise stated.

### Raw Materials:

### Component (A)

Component a: RH-Vi100E is vinyl terminated polydimethylsiloxane having viscosity of less than 100 mPas, manufactured by Zhejiang Runhe Chemical New Material Co., Ltd.

### Component (B)

Component b: RH-H86 is dimethylhydrosiloxane, manufactured Zhejiang Runhe Chemical New Material Co., Ltd.

### Component (C)

Component c-1: AN80 is aluminum nitride powder (D₅₀=70˜100 μm), manufactured by Suzhou Ginet New Material Technology Co., Ltd.

Component c-2: AND-A-01 is aluminum nitride powder (D₅₀=1˜30 μm), manufactured by Suzhou Ginet New Material Technology Co., Ltd.

Component c-3: AA05 is alumina powder (D₅₀=0.5 μm), manufactured by Sumitomo Chemical.

### Component (D)

Component d-1: D2100 is dimethoxy(methyl) silane, manufactured by TCI.

Component d-2: T1035 is trimethoxysilane, manufactured by TCI.

Component d-3: Silquest A 2171 is vinyldimethoxy(methyl) silane, manufactured by Momentive.

Component d-4: Silquest A 171 is vinyltrimethoxysilane, manufactured by Momentive.

Component d-5:9116 is methyltrimethoxysilane, manufactured by Evonik.

### Component (E)

Component e: CATALYST 512 is a divinyl tetramethyl disiloxane complex having 2% by weight of platinum, manufactured by Evonik.

### Component (F)

Component f is red pigment, manufactured by Lanxess.

### Test Methods:

### Flow Rate:

The flow rate of the thermally conductive silicone adhesive composition of the present invention and samples of the comparative examples were tested by a dispenser machine (Nordson Ultimus™-I). The dispenser machine contains a 30 cc plastic tube having a nozzle in a diameter of 2.54+5% mm and the tube is connected to a pressurization unit. When testing, the sample was dispensed under a pressure of 90 psi in 1 minute into a balance tray. The weight of sample dispensed in 1 minute was measured and recorded as flow rate value in Table 1. A larger flow rate value indicates greater flowability for the thermally conductive silicone adhesive composition and superior handling characteristics. The flow rate of more than 15 g/min can be acceptable.

### Thermal Conductivity:

The thermally conductive silicone adhesive composition of the present invention and comparative examples were cured at 125° C. for 1 hour. The thermal conductivity of cured samples of the present invention were tested under temperature of 80° C. and pressure of 40 psi by LW 9389 manufactured by Longwin according to ASTM-D5470. The thermal conductivity of more than 10 W/(m·K) can be acceptable.

### Examples 1 to 5 (Ex. 1 to Ex. 5) and Comparative Examples 1 to 2 (CEx. 1 to CEx. 2)

The inventive and comparative thermally conductive silicone adhesive compositions were produced by mixing the components by weight percentage listed in the Table 1 at room temperature for two hours in a 2-liter planetary mixer (manufactured by Rose (Wuxi) Equipment Co., LTD.) and then cooled down to room temperature. The properties were tested using the methods stated above, and the results of evaluations are shown in Table 1 as below.

TABLE 1

| | | Ex. | Ex. | Ex. | Ex. | Ex. | CEx. | CEx. |
|---|---|---|---|---|---|---|---|---|
| Components (wt. %) | | 1 | 2 | 3 | 4 | 5 | 1 | 2 |
| Component (A) | a | 2.34 | 2.34 | 2.34 | 1.24 | 1.24 | 2.34 | 3.64 |
| Component (B) | b | 1.2 | 1.2 | 1.2 | 2.3 | 2.3 | 1.2 | 1.2 |
| Component (C) | c-1 | 44 | 44 | 44 | 44 | 44 | 44 | 44 |
| | c-2 | 37.3 | 37.3 | 37.25 | 37.25 | 37.25 | 36.35 | 35.95 |
| | c-3 | 15 | 15 | 15 | 15 | 15 | 15 | 15 |
| Component (D) | d-1 | 0.1 | 0.05 | 0 | 0 | 0 | 0 | 0 |
| | d-2 | 0 | 0 | 0.1 | 0 | 0 | 1 | 0 |
| | d-3 | 0 | 0 | 0 | 0.1 | 0 | 0 | 0 |
| | d-4 | 0 | 0 | 0 | 0 | 0.1 | 0 | 0 |
| | d-5 | 0 | 0 | 0 | 0 | 0 | 0 | 0.1 |
| Component (E) | e | 0.01 | 0.01 | 0.01 | 0.01 | 0.01 | 0.01 | 0.01 |
| Component (F) | f | 0.1 | 0.1 | 0.1 | 0.1 | 0.1 | 0.1 | 0.1 |

| | | | | | | | |
|---|---|---|---|---|---|---|---|
| Testing results | | | | | | | |
| Flow rate (g/min) | 22.4 | 19.2 | 18.5 | 20.6 | 18.5 | 11.6 | 10.2 |
| Thermal | 12.1 | 12.6 | 11.5 | 11.9 | 12 | 8.6 | 7.9 |
| Conductivity | | | | | | | |
| (W/(m · K)) | | | | | | | |

As can be seen from Table 1, the thermally conductive silicone adhesives of the present invention (Ex.1 to Ex.5) showed good flowability and high thermal conductivity when cured. However, in the cases where the components of the present invention were not used as in Comparative Examples 1 to 2 (CEx.1 to CEx.2), it showed unsatisfied flow rate compared to the thermally conductive silicone adhesive composition of the present invention, indicating that such adhesive compositions may readily cause nozzle blocking of conventional adhesive dispensers and could not achieve sufficient thermal conductivity for heat dissipating in electronic devices.

Although some preferred embodiments have been described, many modifications and variations may be made thereto in light of the above teachings. It is therefore to be understood that the invention may be practiced otherwise than as specifically described without departing from the scope of the appended claims.

What is claimed is:

1. A thermally conductive silicone adhesive composition comprising:
(A) an alkenyl group-containing organopolysiloxane;
(B) an organohydrogenpolysiloxane having an average of at least two hydrogen atoms directly bonded to a silicon atom in one molecule;
(C) a thermally conductive filler;
(D) a silane coupling agent; and
(E) a catalyst;
wherein the component (D) is selected from the general formulae (i) to (iii) shown below and mixture thereof: 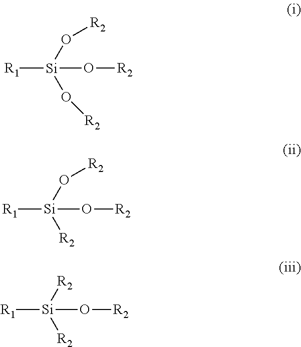
in which in each formula, R₁ independently represents a hydrogen or vinyl group, and R₂ independently represents an alkyl group having 1 to 4 carbon atoms; and
wherein the component (D) is present in an amount of less than 1% by weight based on total weight of the composition.

2. The thermally conductive silicone adhesive composition according to claim 1, wherein the component (A) is selected from any one of the general formulae (iv) to (viii) shown below and mixture thereof: 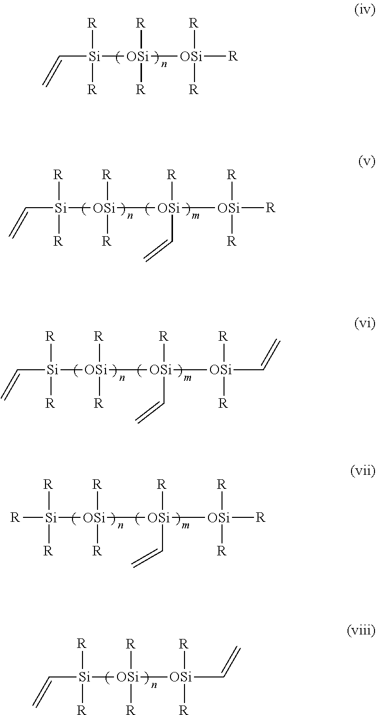
wherein in each formula, R represents a substituted or unsubstituted monovalent hydrocarbon group excluding alkenyl groups, in formulae (iv) to (viii), n is an integer of from 0 to 5000, m is an integer of from 5 to 5000, and the sum of n and m ranges from 5 to 10000.

3. The thermally conductive silicone adhesive composition according to claim 1, wherein the component (A) has a viscosity at 25° C. from 10 to 1000 mPa·s.

4. The thermally conductive silicone adhesive composition according to claim 1, wherein the component (B) is represented by the general formula (ix): 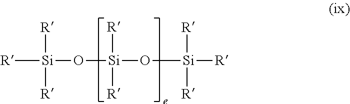
wherein each R′ independently represents a hydrogen atom or an unsubstituted or substituted monovalent hydrocarbon group excluding aliphatic unsaturated bonds and at least two R′ groups are hydrogen atoms; and e represents an integer of 1 or more.

5. The thermally conductive silicone adhesive composition according to claim 1, wherein the component (C) is selected from alumina particles, aluminum nitride particles, fumed silica particles, precipitated silica particles, fumed titanium oxide particles and combinations thereof, optionally selected from alumina particles, aluminum nitride particles and combinations thereof.

6. The thermally conductive silicone adhesive composition according to claim 1, wherein the component (C) has a D₅₀ particle size of no more than 200 μm.

7. The thermally conductive silicone adhesive composition according to claim 6, wherein the component (C) comprises at least one alumina particles having a D₅₀ particle size of 0.01 μm to 2 μm, optionally from 0.1 μm to 1 μm, at least one aluminum nitride particles having a D₅₀ particle size of 1 μm to 200 μm, optionally from 1 μm to 100 μm, and at least one aluminum nitride particles having a D₅₀ particle size of 1 μm to 50 μm, optionally from 1 μm to 30 μm.

8. The thermally conductive silicone adhesive composition according to claim 1, wherein the component (A) is present in an amount of from 0.01% to 5%, optionally from 0.05% to 4% by weight, based on the total weight of the composition.

9. The thermally conductive silicone adhesive composition according to claim 1, wherein the component (B) is present in an amount of from 0.01% to 5%, optionally from 0.05% to 3% by weight, based on the total weight of the composition.

10. The thermally conductive silicone adhesive composition according to claim 1, wherein the component (C) is present in an amount of from 0.01% to 99% by weight, optionally from 50% to 99% by weight, based on the total weight of the composition.

11. The thermally conductive silicone adhesive composition according to claim 1, wherein the component (D) is present in an amount of from 0.01% to less than 1% by weight, optionally from 0.05% to less than 1% by weight, based on the total weight of the composition.

12. The thermally conductive silicone adhesive composition according to claim 1, wherein the component (E) is present in an amount of from 0.001% to 0.1% by weight, optionally from 0.001% to 0.05% by weight, based on the total weight of the composition.

13. A method for preparing the thermally conductive silicone adhesive composition according to claim 1, comprising a step of mixing the components simultaneously at room temperature.

14. A cured product of the thermally conductive silicone adhesive composition according to claim 1.

15. The thermally conductive silicone adhesive composition according to claim 1, wherein the component (A) has a viscosity at 25° C. of from 10 to 100 mPa·s.

16. The thermally conductive silicone adhesive composition according to claim 15, wherein the component (C) is selected from alumina particles, aluminum nitride particles, fumed silica particles, precipitated silica particles, fumed titanium oxide particles and combinations thereof and the component (C) has a D₅₀ particle size of no more than 200 μm.

17. The thermally conductive silicone adhesive composition according to claim 1, wherein the component (A) is present in an amount of from 0.05% to 4% by weight; the component (B) is present in an amount of from 0.05% to 3% by weight; the component (C) is present in an amount of from 50% to 99% by weight; the component (D) is present in an amount of from 0.05% to less than 1% by weight; the component (E) is present in an amount of from 0.001% to 0.05% by weight, all based on the total weight of the composition; and the component (C) has a D₅₀ particle size of no more than 100 μm.

18. The thermally conductive silicone adhesive composition according to claim 1, wherein the component (C) is selected from alumina particles, aluminum nitride particles and combinations thereof.

19. The thermally conductive silicone adhesive composition according to claim 18, wherein the component (C) comprises at least one alumina particles having a D₅₀ particle size of 0.01 μm to 2 μm, optionally from 0.1 μm to 1 μm, at least one aluminum nitride particles having a D₅₀ particle size of 1 μm to 200 μm, optionally from 1 μm to 100 μm, and at least one aluminum nitride particles having a D₅₀ particle size of 1 μm to 50 μm, optionally from 1 μm to 30 μm.

20. The thermally conductive silicone adhesive composition according to claim 2, wherein: the component (A) is present in an amount of from 0.01% to 5% by weight the component (B) is present in an amount of from 0.01% to 5% by weight; the component (C) is present in an amount of from 0.01% to 99% by weight; the component (D) is present in an amount of from 0.01% to less than 1% by weight; the component (E) is present in an amount of from 0.001% to 0.1% by weight; all based on the total weight of the composition.
